(19) United States
(12) Patent Application Publication
(10) Pub. No.: US 2024/0412123 A1
(43) Pub. Date: Dec. 12, 2024

(54) METHODS AND SYSTEMS FOR GUARANTEEING SMART GAS DEMAND BASED ON REGULATORY INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Junyan ZHOU, Chengdu (CN); Siwei ZENG, Chengdu (CN); Lei HE, Chengdu (CN)

(73) Assignee: CHENGDU QINCHUAN IOT TECHNOLOGY CO., LTD., Chengdu (CN)

(21) Appl. No.: 18/813,000

(22) Filed: Aug. 22, 2024

(30) Foreign Application Priority Data
Jul. 8, 2024 (CN) 202410905430.1

(51) Int. Cl. G06Q 10/04; G06Q 10/0631; G06Q 50/06

(52) U.S. Cl. CPC G06Q 10/04; G06Q 10/06315; G06Q 50/06

(57) ABSTRACT

Disclosed is a method for guaranteeing a smart gas demand based on a regulatory Internet of Things (IoT). The method is executed by a gas company management platform. The method includes: obtaining a plurality of grid regions by gridding a regulatory scope; predicting a gas demand degree of each of the plurality of grid regions in a future time period based on weather data, people flow data, historical gas data, and a gas consumption plan, and an authenticity degree of the gas consumption plan; determining a scheduling parameter based on the gas demand degree and schedulable resource data in the future time period; and generating a scheduling instruction based on the scheduling parameter, and sending the scheduling instruction to a terminal device corresponding to a schedulable resource device.

### CROSS-REFERENCE TO RELATED APPLICATION

This application claims priority of Chinese Patent Application No. 202410905430.1 filed on Jul. 8, 2024, the contents of which are entirely incorporated herein by reference.

### TECHNICAL FIELD

The present disclosure relates to the technical field of gas demand regulation, and in particular to a method and system for guaranteeing a smart gas demand based on a regulatory Internet of Things.

### BACKGROUND

Currently, the use of gas is continuously promoted and popularized, which is able to cover most regions. In gas management, it is necessary to regulate the use of gas in different regions to ensure the safety of gas use. At the same time, it may provide data with reference values for gas scheduling. Because of different use conditions of gas in different regions, the data generated may also have a great difference, the gas company's ability to analyze the data in a timely and effective manner greatly affects a gas scheduling program and efficiency.

There is therefore a need to provide an improved method and system for guaranteeing a smart gas demand based on a regulatory Internet of Things (IoT) to improve the efficiency and accuracy of scheduling gas.

### SUMMARY

One or more embodiments of the present disclosure provide a method for guaranteeing a smart gas demand based on a regulatory Internet of Things (IoT). The method may be executed by a gas company management platform of a system for guaranteeing the smart gas demand based on the regulatory IoT. The method may include: obtaining a plurality of grid regions by gridding a regulatory scope; predicting a gas demand degree of each of the plurality of grid regions in a future time period based on weather data, people flow data, historical gas data, and a gas consumption plan of the each of the plurality of grid regions, and an authenticity degree of the gas consumption plan; determining a scheduling parameter based on the gas demand degree and schedulable resource data in the future time period; generating a scheduling instruction based on the scheduling parameter, and sending the scheduling instruction to a terminal device corresponding to a schedulable resource device.

One of the embodiments of the present disclosure provides a system for guaranteeing the smart gas demand based on the regulatory Internet of Things (IoT). The system may include a civilian user platform, a government regulatory service platform, a government regulatory management platform, a government regulatory sensor network platform, a government regulatory object platform, a gas company sensor network platform and a gas device object platform. The government regulatory service platform may include a government safety regulatory service platform. The government regulatory management platform may include a government safety regulatory management platform. The government regulatory object platform may include a gas company management platform. The gas company management platform may be configured to: obtain a plurality of grid regions by gridding a regulatory scope; predict a gas demand degree of each of the plurality of grid regions in a future time period based on weather data, people flow data, historical gas data, and a gas consumption plan of each of the plurality of grid regions, and an authenticity degree of the gas consumption plan; determine a scheduling parameter based on the gas demand degree and schedulable resource data in the future time period; generate a scheduling instruction based on the scheduling parameter, and send the scheduling instruction to a terminal device corresponding to a schedulable resource device.

One or more embodiments of the present disclosure provide a non-transitory computer-readable storage medium, the storage medium storing computer instructions, and when the computer reads the computer instructions in the storage medium, the computer executes the method for guaranteeing a smart gas demand based on a regulatory Internet of Things (IoT).

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same counting denotes the same structure, wherein:

FIG. 1 is a schematic diagram illustrating a platform structure of a system for guaranteeing a smart gas demand based on a regulatory Internet of Things (IoT) according to some embodiments of the present disclosure;

FIG. 2 is a flowchart illustrating a method for guaranteeing a smart gas demand based on a regulatory IoT according to some embodiments of the present disclosure;

FIG. 3 is a schematic diagram illustrating a structure of a demand prediction model according to some embodiments of the present disclosure;

FIG. 4 is a schematic diagram illustrating gridding according to some embodiments of the present disclosure;

FIG. 5 is a schematic diagram illustrating a first adjustment according to some embodiments of the present disclosure;

FIG. 6 is a schematic diagram illustrating a second adjustment according to some embodiments of the present disclosure;

FIG. 7 is a schematic diagram illustrating a process for determining an adjustment parameter according to some embodiments of the present disclosure; and

FIG. 8 is a schematic diagram illustrating a process for determining a satisfaction degree of an initial adjustment parameter according to some embodiments of the present disclosure.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios in accordance with these drawings without creative labor. The present disclosure may be applied to other similar scenarios based on these drawings without creative labor. Unless obviously obtained from the context or the context illustrates otherwise, the same numeral in the drawings refers to the same structure or operation.

It should be understood that the terms “system,” “device,” “unit” and/or “module” as used herein are a way to distinguish between different components, elements, parts, sections, or assemblies at different levels. However, these words may be replaced by other expressions if other words accomplish the same purpose.

As shown in the present disclosure and the claims, unless the context clearly suggests an exception, the words “one,” “a,” “an,” and/or “the” do not refer specifically to the singular, but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or device may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, the operations can be processed in reverse order or simultaneously. Also, it is possible to add other operations to these processes or remove an operation or operations from them.

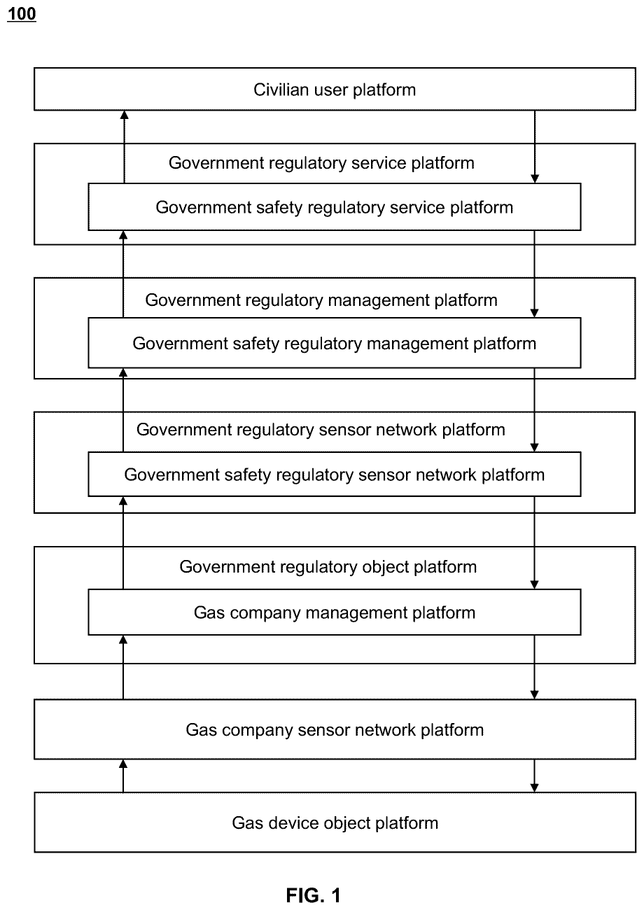

FIG. 1 is a schematic diagram illustrating a platform structure of a system for guaranteeing a smart gas demand based on a regulatory Internet of Things (IoT) according to some embodiments of the present disclosure.

In some embodiments, the system for guaranteeing a smart gas demand based on the regulatory IoT 100 includes a civilian user platform, a government regulatory service platform, a government regulatory management platform, a government regulatory sensor network platform, a government regulatory object platform, a gas company sensor network platform, and a gas device object platform.

The civilian user platform refers to a platform dominated by a gas user. In some embodiments, the civilian user platform may interact with the government regulatory service platform. For example, the civilian user service platform may obtain a gas demand degree as well as a gas consumption plan and upload the gas demand degree and the gas consumption plan to the government regulatory service platform.

In some embodiments, the government regulatory service platform is used to provide information related to gas operation regulatory services.

In some embodiments, the government regulatory service platform may include a government safety regulatory service platform. The government safety regulatory service platform may be used to obtain gas demand degrees, gas consumption plans, or the like.

In some embodiments, the government regulatory service platform may interact with the civilian user platform in a bidirectional manner with the government regulatory management platform. For example, the government regulatory service platform may obtain weather data, people flow data, or the like, and upload them to the government regulatory management platform. For another example, the government regulatory service platform may obtain the gas demand degrees and the gas consumption plans from the civilian user platform and upload them to the government regulatory management platform.

The government regulatory management platform refers to a comprehensive management platform for government regulatory information. In some embodiments, the government regulatory management platform may be configured for data processing and storage of the system for guaranteeing the smart gas demand based on the regulatory IoT.

In some embodiments, the government regulatory management platform may include a government safety regulatory management platform. The government safety regulatory management platform may be used to obtain the gas demand degrees, the gas consumption plans, the weather data, the people flow data, or the like.

In some embodiments, the government regulatory management platform may interact with the government regulatory sensor network platform. For example, the government regulatory management platform may send a data request to a gas company management platform via the government regulatory sensor network platform to obtain various types of data, such as historical gas data. For example, the government regulatory management platform may obtain the gas demand degrees, the gas consumption plans, the weather data, the people flow data, or the like from the government regulatory service platform and upload them to the government regulatory sensor network platform.

The government regulatory sensor network platform refers to a platform for comprehensive management of government sensor information. In some embodiments, the government regulatory sensor network platform may include a government security regulatory sensor network platform.

In some embodiments, the government regulatory sensor network platform may interact with the government regulatory management platform and the government regulatory object platform. For example, the government regulatory sensor network platform may send the aforementioned types of data, (e.g., the gas demand degrees, the gas consumption plans, the weather data, etc.) to the government regulatory object platform.

The government regulatory object platform refers to a platform for generating government regulatory information and controlling the execution of the information. In some embodiments, the government regulatory object platform may include a gas company management platform. The gas company management platform may be used to obtain information related to a schedulable resource device, etc.

In some embodiments, the gas company management platform may interact with the government regulatory sensor network platform and the gas company sensor network platform. For example, the gas company management platform may obtain information about the schedulable resource device from the gas device object platform via the gas company sensor network platform and send scheduling instructions to the gas device object platform.

In some embodiments, the gas company management platform may include a communication module and a processor.

In some embodiments, the communication module may be configured for communication and messaging between various platforms and devices in the system for guaranteeing the smart gas demand based on the regulatory IoT.

In some embodiments, the processor may process information and/or data related to the system for guaranteeing a smart gas demand based on the regulatory IoT to perform functions described in the present disclosure.

The processor may be used to collect, analyze, and process data, generate corresponding control instructions based on the data, and send the control instructions to an actuator to cause the actuator to perform a corresponding action or function. For example, the control instructions may be issued to the communication module so that the communication module performs at least one of the functions of initiating, relating, obtaining data, transmitting data, or the like.

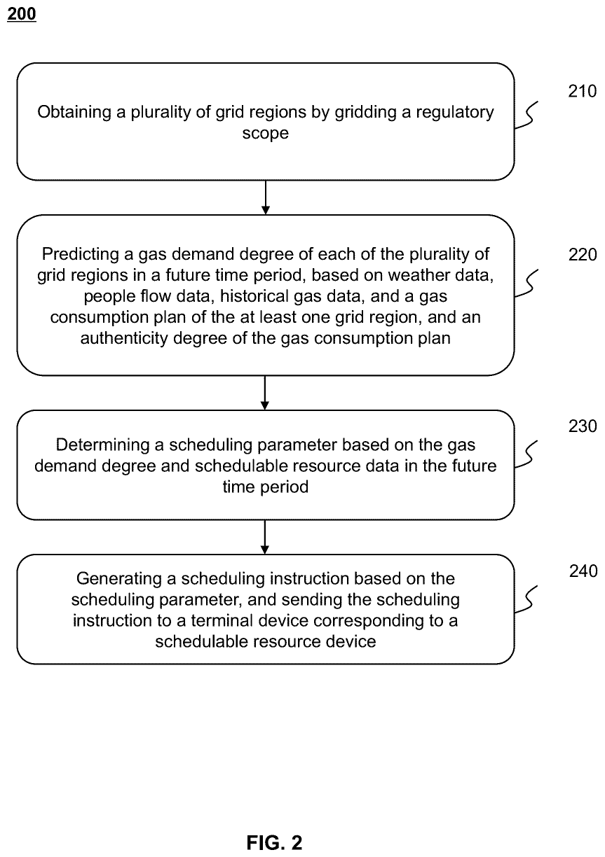

In some embodiments, the processor may obtain, via the communication module, the weather data and the people flow data from the government regulatory service platform; obtain, via the communication module, the schedulable resource data from the gas device object platform; obtain, via a communication module, a gas consumption plan and the corresponding authenticity degree from the civilian user platform; and send, via the communication module, the scheduling instructions to a terminal device corresponding to the schedulable resource device to control the scheduling of the schedulable resource device. For more information about the weather data, the people flow data, the schedulable resource data, the gas consumption plan, the scheduling instruction, and the authenticity degree corresponding to the gas consumption plan, please refer to FIG. 2.

By adopting the processor and the communication module, it is possible to realize the functions of automated data transmission, data processing, and automated control, which improves the degree of automation of the system for guaranteeing a smart gas demand based on the regulatory IoT, and is able to increase the efficiency and accuracy of a gas scheduling.

In some embodiments, the gas company sensor network platform is used to manage sensor communications. In some embodiments, the gas company sensor network platform may implement functions of perceptual information sensing communication and control information sensing communications. In some embodiments, the gas company sensor network platform may be configured as a communication network or a gateway, etc.

In some embodiments, the gas company sensor network platform may be in bi-directional communication with the gas device object platform to receive data obtained by the gas device object platform. In some embodiments, the gas company sensor network platform may receive the data related to the schedulable resource device obtained by the gas device object platform and upload the data to the gas company management platform.

In some embodiments, the gas device object platform may be a functional platform for perceptual information generation and controlling information execution.

In some embodiments, the gas device object platform may include the schedulable resource device.

In some embodiments, the gas device object platform may interact bi-directionally with the gas company sensor network platform. For example, the gas device object platform may receive, via the gas company sensor network platform, the scheduling instructions issued by the gas company management platform, and issue the scheduling instructions to the terminal device corresponding to the schedulable resource device to control schedulable scheduling of the schedulable resource device.

In some embodiments of the present disclosure, the platforms of the system for guaranteeing a smart gas demand based on the regulatory IoT may be coordinated and regularly operated under unified management of the gas company management platform, and the gas demand may be collected, judged, and managed in a standardized manner, so as to achieve informatization and intelligence of gas distribution.

In some embodiments, the platforms in the system for guaranteeing a smart gas demand based on the regulatory IoT may be divided into a smart gas primary network and a smart gas secondary network. The smart gas primary network refers to a network in which government users regulate the operation of a gas pipeline network. The smart gas secondary network may include a network in which the gas pipeline network operates. In some embodiments, a same platform in the system for guaranteeing a smart gas demand based on the regulatory IoT may assume different roles in the smart gas primary network and the smart gas secondary network.

In some embodiments, the smart gas primary network may at least include a smart gas primary network user platform, a smart gas primary network service platform, a smart gas primary network management platform, a smart gas primary network sensor network platform, and a smart gas primary network object platform. The smart gas primary network user platform may include the civilian user platform, the smart gas primary network service platform may include the government regulatory service platform, the smart gas primary network management platform may include the government regulatory management platform, the smart gas primary network sensor network platform may include the government regulatory sensor network platform, and the smart gas primary network object platform may include the government regulatory object platform.

In some embodiments, the smart gas secondary network may at least include a smart gas secondary network management platform, a smart gas secondary network sensor network platform, and a smart gas secondary network object platform. The smart gas secondary network management platform may include the gas company management platform, the smart gas secondary network sensor network platform may include the gas company sensor network platform, and the smart gas secondary network object platform may include the gas device object platform.

For detailed contents of the contents of the system for guaranteeing the smart gas demand based on the regulatory IoT, please refer to relevant descriptions of FIG. 2 to FIG. 5.

It should be noted that the above description of the system for guaranteeing the smart gas demand based on the regulatory IoT and the compositions thereof are provided only for descriptive convenience, and does not limit the present disclosure to the scope of the embodiments. It is to be understood that for those skilled in the art, with an understanding of the principle of the system, it may be possible to arbitrarily combine various platforms or constitute subsystems to be connected to other modules and/or platforms, or platform connections without departing from this principle.

FIG. 2 is a flow chart illustrating a method for guaranteeing a smart gas demand based on a regulatory IoT according to some embodiments of the present disclosure. As shown in FIG. 2, a process 200 includes the following steps. In some embodiments, the process 200 may be performed by a gas company management platform.

In step 210, obtaining a plurality of grid regions by gridding a regulatory scope.

The regulatory scope refers to a region in which gas use needs to be regulated. In some embodiments, the regulatory scope may include at least one of a city, a district, a county, a street, or the like. In some embodiments, the regulatory scope may include management scopes of a plurality of gas companies.

The gridding refers to a subdivision of the regulatory scope into a plurality of small units. In some embodiments, the gas company management platform may divide the regulatory scope into the plurality of small units based on a preset size. The preset size may include at least one of an area of the unit, a proportion of the unit relative to the regulatory scope, or the like.

In some embodiments, the preset size may be obtained based on at least one of experience, historical data, or the like.

The grid refers to a single, small cellular region formed when the regulatory scope is divided. In some embodiments, the grid may be at least one of a rectangle, a triangle, a hexagon, or the like. In some embodiments, the gas company management platform may number the grid.

In 220, predicting a gas demand degree of each of the plurality of grid regions in a future time period based on weather data, people flow data, historical gas data, and a gas consumption plan of the grid region, and an authenticity degree of the gas consumption plan.

The weather data refers to data related to the weather. For example, the data may include at least one of season, a temperature, a rainfall, a wind direction, etc.

In some embodiments, the gas company management platform may obtain the weather data in various ways, for example, obtain through at least one of a sensor a detection, a manual input, or from other external systems (e.g., a weather system), or the like.

The people flow data refers to data related to a number of people within the regulatory scope. For example, the data may include at least one of a number of people, a population inflow, a population outflow, or the like, within the regulatory scope.

In some embodiments, the gas company management platform may obtain the people flow data in various ways, for example, obtain through at least one of the historical data, the manual input, obtaining from other external systems (e.g., traffic monitoring), or the like.

The gas data refers to data related to gas usage. In some embodiments, the gas data may include, within a time range, a time corresponding to a peak of the gas usage and a corresponding amount of usage, a time corresponding to a valley of the gas usage and the corresponding amount of usage. The historical gas data refers to the gas data generated over a historical time period.

In some embodiments, the gas company management platform may obtain the historical gas data in various ways. For example, the historical gas data may be obtained through at least one of the historical data, the manual input, or the like.

The gas consumption plan refers to a plan for gas usage of a gas user over a period of time. For example, the gas consumption plan may include, in a future month, an estimated gas consumption (also referred to as amount of usage) by a specific gas user, or an estimated gas consumption by users in a specific region.

In some embodiments, the gas user may estimate the gas consumption plan in various ways. For example, the estimation may be based on the gas usage during a historical time period, and in some embodiments, the gas user may upload the gas consumption plan to the gas company management platform via a user terminal.

The authenticity degree refers to an estimation result obtained by the gas company management platform after estimating the gas consumption plan. There may be a misjudgment in the gas consumption plan uploaded by the gas user, thus there is a need to determine the authenticity degree of the gas consumption plan. The higher the authenticity degree, the more accurate the gas consumption plan uploaded by the user.

In some embodiments, the gas company management platform may determine the authenticity degree in various ways. For example, the gas company management platform may obtain a historical gas consumption plan of the gas user from the historical data, construct a vector based on the historical gas consumption plan and a vector database, the vector database including the vectors constructed from the historical gas consumption plans and their corresponding authenticities. The gas company management platform may construct the vector based on the gas consumption plan, compare a similarity of the vector constructed from the gas consumption plan with the vectors constructed from the historical gas consumption plans in the vector database, and determine the authenticity degree of the historical gas consumption plan with the highest similarity as the authenticity degree of the gas consumption plan.

The gas demand degree refers to an amount of gas that the gas user actually needs in a future period of time. For example, the gas demand may be the amount of gas that a specific gas user actually needs to use in the next month. In some embodiments, the gas company management platform may predict the gas demand degree of the grid in the future time period in various ways based on the weather data, the people flow data, the historical gas data, the gas consumption plan, and the authenticity degree of the gas consumption plan.

In some embodiments, the gas company management platform may cluster the historical data to obtain at least one clustering center based on sample weather data, sample people flow data, sample gas data, sample gas consumption plan, sample authenticity degree corresponding to the sample gas consumption plan, and sample gas demand degree. Based on the sample weather data, the sample people flow data, the sample gas data, the sample gas consumption plan, and the sample authenticity degree corresponding to the aforementioned clustering center, at least one standard vector is determined.

The gas company management platform may construct a to-be-matched vector based on the weather data, the people flow data, the historical gas data, the gas consumption plan, and the authenticity degree corresponding to the gas consumption plan. The gas company management platform may calculate a similarity between the to-be-matched vector and the at least one standard vector, and determine a historical gas demand degree corresponding to the standard vector with the highest similarity as a target gas demand degree.

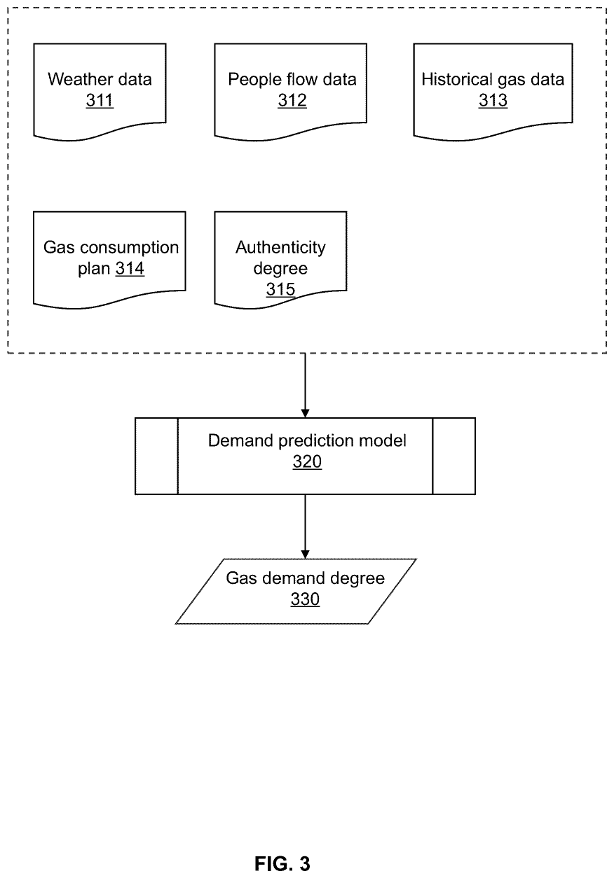

In some embodiments, the gas company management platform may also predict, based on the weather data, the people flow data, the historical gas data, the gas consumption plan, and the authenticity degree corresponding to the gas consumption plan, the gas demand degree in the grid region in a future time period through a demand prediction model. For detailed contents, please refer to relevant descriptions of FIG. 3.

In step 230, determining a scheduling parameter based on the gas demand degree and schedulable resource data in the future time period.

The schedulable resource data refers to data associated with a schedulable resource device. The schedulable resource device refers to a device used to schedule gas, such as at least one of a temporary gas vehicle, a gas storage tank, or the like.

In some embodiments, the schedulable resource data may include at least one of temporary gas vehicle data, gas storage tank data, or the like.

The temporary gas vehicle data may include at least one of a storage capacity of the temporary gas vehicle, a position of a gas vehicle, a movement speed, a company to which the gas vehicle belongs, or the like. The gas vehicle position may include a current position of the temporary gas vehicle (e.g., a current grid region).

The gas storage tank data may include at least one of a gas storage capacity of the storage tank, a reserve tank position, a gas supply rate, and the company to the gas vehicle belongs, or the like. The reserve tank position may include the current position of the reserve tank (e.g., the current grid region).

In some embodiments, the gas company management platform may obtain scheduling parameter in multiple ways. For example, through at least one of a sensor, a trip recorder, a manual input, etc.

The scheduling parameter refers to a parameter associated with a scheduling gas for the schedulable resource device. In some embodiments, the scheduling parameter may include at least one of an operation destination of one or more temporary gas vehicles, an opening and closing state of one or more gas reserve tanks and their transportation directions, etc.

In some embodiments, the gas company management platform may compare the gas demand degree for each grid region and a gas supply threshold for the corresponding grid region, and based on a comparison result, label a gas supply and demand situation of the grid region. For example, label the situation of each grid region as −1, 0, 1. The −1, 0, 1 may indicate that the gas demand degree is greater than, equal to, or less than the gas supply threshold, respectively. The gas supply threshold refers to a maximum value of gas supplied to each grid region.

In some embodiments, the gas supply threshold may be obtained in various ways, for example, at least one of obtaining from historical data, calculating based on a first preset algorithm, or the like.

In some embodiments, the first preset algorithm may include, gas supply threshold=standard supply×(actual grid size/standard grid size). The standard grid refers to a unit area used as a reference standard, and the standard grid size refers to the size of the standard grid. For example, standard grid size=1 unit length×1 unit length. In some embodiments, the unit length may be 1 cm, for example. The standard supply refers to a threshold of gas that the standard grid supplies.

In some embodiments, the gas company management platform may process the grids marked as −1 one by one until all grids are marked as a value of 0. For example, if a first grid exists that is marked as −1, one or more second grids closest to the first grid may be selected to schedule gas from the second grid to the first grid, and the aforementioned second grid may be marked as 1.

In some embodiments, the gas that is able to be scheduled for the second grid may be equal to a gas maximum for the second grid minus the gas supply threshold of the second grid. In some embodiments, the gas needs to be scheduled for the first grid may be equal to the gas supply threshold of the first grid minus the gas maximum of the first grid. The scheduling parameter may include scheduling the gas needs to be scheduled for the first grid from the second grid to the first grid.

In some embodiments, when the gas that is able to be scheduled for the second grid is greater than the gas needs to be scheduled for the first grid, schedule only the amount of gas needs to be scheduled for the first grid may be scheduled to the first grid.

In some embodiments, when the schedulable resource device of the second grid includes both a plurality of the temporary gas vehicles and the gas storage tank, the schedulable resource device may be scheduled in accordance with a preset rule, such as at least one of prioritizing the temporary gas vehicle scheduling, prioritizing the gas storage tank, or the like. After the scheduling is completed, the first grid may be marked as 0. The gas in the second grid that exceeds the gas supply threshold may continue to be scheduled.

In some embodiments, when the gas that is able to be scheduled for the second grid is equal to the gas that needs to be scheduled for the first grid, an amount of the gas that needs to be scheduled for the first grid may be scheduled to the first grid. After the scheduling is complete, the first grid and the second grid may be labeled as 0.

In some embodiments, when the gas that is able to be scheduled for the second grid is less than the gas that needs to be scheduled for the first grid, the gas company management platform may select a third grid, a fourth grid, or the like, and schedule gas from one of the third grid or the fourth grid, or the like. The aforementioned third grid and fourth grid may be labeled as 1.

In some embodiments, the gas company management platform may also schedule all of the gas in the second grid, the third grid, the fourth grid, or the like to the first grid at the same time until the gas scheduled satisfies demand of the first grid. After the scheduling is completed, the first grid and the second grid may be labeled as 0. For the third grid and the fourth grid, the labeling may be adjusted based on their respective gas demand degrees and gas supply thresholds. The way for determining the labeling may be found in the previous description.

In step 240, generating a scheduling instruction based on the scheduling parameter, and sending the scheduling instruction to a terminal device corresponding to the schedulable resource device.

The scheduling instruction refers to a control instruction that controls the schedulable resource device so that it schedules the gas according to the scheduling parameter.

In some embodiments, the gas company management platform may generate the scheduling instruction based on the scheduling parameter. For example, the scheduling parameter may be scheduling the gas needs to be scheduled for the first grid from the second grid to the first grid. The scheduling instruction may include, controlling the schedulable resource device in the second grid to carry the gas that needs to be scheduled from the first grid and schedule the gas to the first grid.

The terminal device refers to a device used by an operator to receive scheduling instruction, for example, at least one of a cell phone, a computer, or the like. The operator refers to a person who executes the scheduling instruction. In some embodiments, the operator may be configured in correspondence with the schedulable resource device. For example, one schedulable resource device corresponds to one operator. For example, the schedulable resource device may be the temporary gas vehicle or the gas storage tank.

In some embodiments, the gas company management platform may obtain a scheduling table in advance, determine the relevant operator based on the scheduling table, and thus determine the terminal device that the schedulable resource device currently corresponds to.

According to some embodiments of the present disclosure, through gridding the regulatory region, the gas company management platform may be able to divide the gas and the gas demand degree in different grids, so as to improve the accuracy of confirming the gas demand degree, improve the accuracy of scheduling the gas demand degree, and improve the accuracy of scheduling gas.

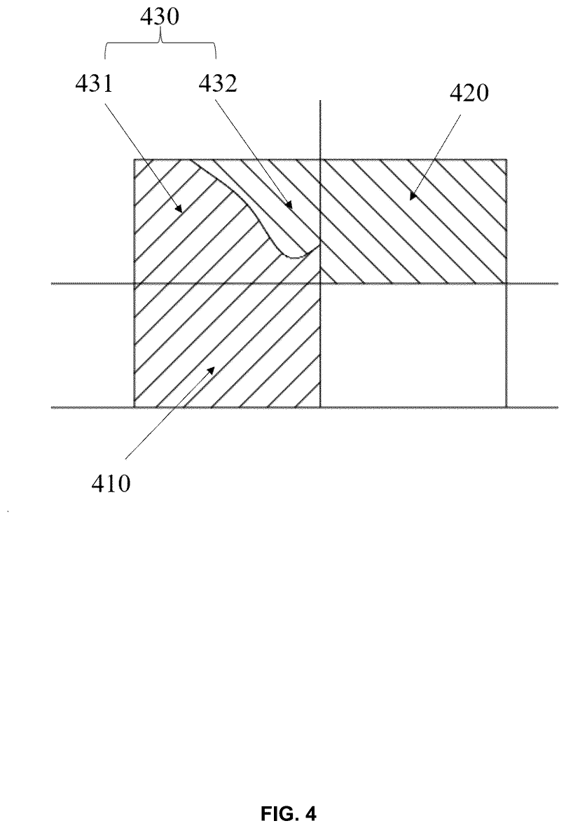

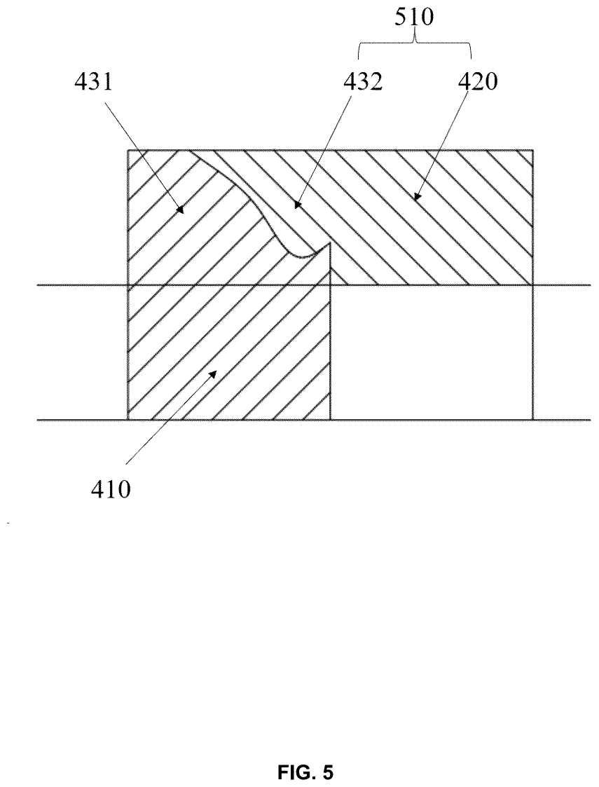

FIG. 3 is schematic diagram illustrating a structure of a demand prediction model according to some embodiments of the present disclosure. FIG. 4 is a schematic diagram illustrating gridding according to some embodiments of the present disclosure. FIG. 5 is a schematic diagram illustrating a first adjustment according to some embodiments of the present disclosure.

In some embodiments, as shown in FIG. 4, and FIG. 5, a gas company management platform may perform, based on a gas demand degree of a plurality of grid regions and management regions of a plurality of gas companies, first adjustments on the plurality of grid regions to determine a plurality of adjusted grid regions.

The first adjustment refers to an adjustment on one or more grid regions. The first adjustment may include splitting and/or merging the grid regions. After the first adjustment, the individual adjusted grid region may be made to be out of the management region of the same gas company.

In some embodiments, the gas company management platform may split and/or merge the individual grid regions based on the gas demand degree in a future time period in each grid region and the management region of the gas company. For example, the gas company management platform may traverse each of the grid regions, split the grid regions under jurisdiction of a plurality of companies into a plurality of regions in accordance with the management regions of the gas companies, until all of the grid regions are each governed by only one company.

As shown in FIG. 4, a first grid region 410, a second grid region 420, and a third grid region 430, or the like, may be obtained by gridding of the regulatory scope. The first grid region 410 may be under the jurisdiction of the first company, the second grid region 420 may be under the jurisdiction of the second company, and the third grid region 430 may be under joint jurisdiction of the first company and the second company. The third grid region 430 may be divided into a first portion 431 and a second portion 432 based on a boundary of the regions under the jurisdiction of the first company and the second company. The first portion 431 may be under the jurisdiction of the first company and the second portion 432 may be under the jurisdiction of the second company.

In some embodiments, the gas company management platform may compare a size of an area of the region after the grid split with an area threshold, and when the area of the region after the grid split is greater than the area threshold, the region may be a single grid; when the area of the split grid is smaller than or equal to the area threshold, the region may be merged with surrounding grids under the jurisdiction of the same company.

The area threshold may be a preset value. In some embodiments, the gas company management platform may determine the area threshold in various ways, for example, based on at least one of experience, historical data, manual input, or the like.

For example, as shown in FIG. 5, the area of the first portion 431 may be greater than the area threshold, and the first portion 431 may be a single grid. The area of the second portion 432 may be less than the area threshold, and the second portion 432 may be merged with the second grid 420 to form a fourth grid 510, and in response to that the area of the fourth grid 510 is smaller than the area threshold, there is no need for further adjustment, and in response to hat the area of the fourth grid 510 is not smaller than the area threshold, further adjustment may be required. For example, the fourth grid 510 whose area is not smaller than the area threshold may be further split.

In some embodiments, as shown in FIG. 3, the gas company management platform may predict, based on the weather data 311, the people flow data 312, the historical gas data 313, the gas consumption plan 314, and the authenticity degree 315, a demand degree 330 of the grid in a future time by means of the demand prediction model 320. The demand degree 330 of the grid in a future time refers to a gas demand degree of each grid in a future time period.

The demand prediction model 320 refers to a model used to determine the demand degree 330 for the grid region in a future time. The demand prediction model 320 may be a machine learning model.

In some embodiments, an input to the demand prediction model 320 may include the weather data 311, the people flow data 312, the historical gas data 313, the gas consumption plan 314, and the authenticity degree 315, and an output may include the demand degree 330 of the grid in a future time. For more contents on the weather data 311, the people flow data 312, the historical gas data 313, the gas consumption plan 314, and the authenticity degree 315, please refer to the related descriptions of FIG. 2.

In some embodiments, the demand prediction model may be obtained by training a plurality of first training samples with first labels. The government regulatory management platform may input the plurality of first training samples with the first labels into an initial demand prediction model, construct a loss function through the first label and a result of the initial demand prediction model, and based on the loss function, a parameter of the initial demand prediction model may be iteratively updated. The model training may be completed when the loss function of the initial demand prediction model satisfies a preset condition, and a trained demand prediction model may be obtained. The preset condition may be that the loss function converges, a number of iterations reaches a threshold, or the like.

In some embodiments, the first training sample may include, in the historical data, the weather data, the people flow data, the historical gas data, the gas consumption plan, and the authenticity degree for each of the grids during a historical first time. The first label may be an amount of gas actually used by a user during a historical second time. The historical second time may be later than the historical first time.

By performing the first adjustment to the grids so that the gas demand degree within each of the adjusted grids is less than a threshold, and the gas demand degree of the single grid is reduced, which facilitates a reduction of the amount of gas to be scheduled in a single schedule, thereby reducing a difficulty of scheduling. After the first adjustment, each grid may be under the jurisdiction of the same gas company, and when the gas scheduling is subsequently performed for each grid, only a single gas company may participate in the scheduling, so as to reduce the difficulty of scheduling by the gas company, and facilitate the management of the gas company. By adopting the demand prediction model, it may be possible to quickly predict the demand degree of the grid in the future time, and to improve the accuracy of the predicted demand degree, which is conducive to improving the accuracy and efficiency of the scheduling.

In some embodiments, the input to the demand prediction model may also include a historical demand degree and a historical satisfaction degree for the grid over a historical time period.

The historical demand degree refers to the gas demand degree corresponding to the grid during the historical time period. In some embodiments, the gas company management platform may obtain the historical demand degree from the historical data. For more contents about the gas demand degree, please refer to the related descriptions in FIG. 2.

The historical satisfaction degree refers to a satisfaction degree of the user on the gas supply in the grid region over a historical time period. In some embodiments, the gas company management platform may obtain the historical satisfaction degree from the historical data. For more about the satisfaction degree, please refer to the descriptions in FIG. 5.

In some embodiments, when the input to the demand prediction model includes the historical demand degree and the historical satisfaction degree for the grid region during the historical time period, the first training sample for training the initial demand prediction model may further include a sample historical demand degree and a sample historical satisfaction degree of the grid region during a third time period. The historical third time may be earlier than the historical first time.

In some embodiments of the present disclosure, the historical demand degree and the historical satisfaction degree may be used as the input to the demand prediction model, and when training the demand prediction model, the output of the demand prediction model may be made to correlate the historical demand degree and the historical satisfaction degree. In this way, the accuracy of the trained demand prediction model may be improved.

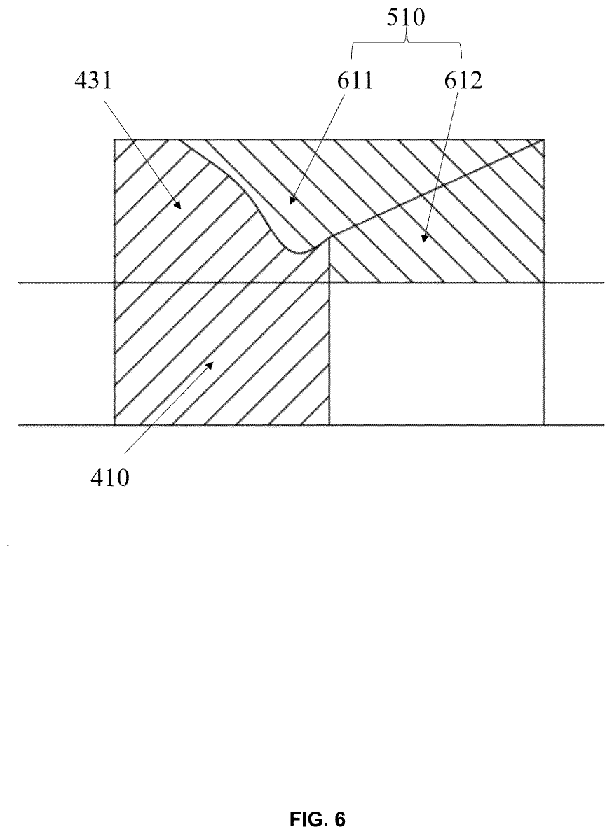

FIG. 6 is a schematic diagram illustrating a second adjustment according to some embodiments of the present disclosure.

In some embodiments, as shown in FIG. 6, the gas company management platform may perform, based on adjusted demand degrees and adjusted satisfaction degrees of a plurality of adjusted grid regions, the second adjustment to the adjusted grid regions whose adjusted satisfaction degree does not satisfy a preset condition.

The adjusted demand degree refers to a gas demand degree corresponding to the adjusted grid region recalculated after the grid has been adjusted by the first adjustment. In some embodiments, the gas company management platform may determine the adjusted demand degree for the adjusted grid region at a future time using a demand prediction model.

For example, weather data, people flow data, historical gas usage data, a gas consumption plan and the authenticity degree thereof of the adjusted grid region may be input to the demand prediction model for determine the gas demand degree corresponding to the adjusted grid region. For detailed descriptions of obtaining the demand prediction model, as well as the weather data, the people flow data, the historical gas usage data, the gas consumption plan, and the authenticity degree thereof, please refer to the aforementioned descriptions of the present disclosure.

The adjusted satisfaction degree refers to a satisfaction degree corresponding to the recalculated adjusted grid region after the first adjustment of the grid region.

In some embodiments, the gas company management platform may construct a scheduling map based on the adjusted grid region division obtained after the first adjustment and a distribution of a schedulable resource device in each of the adjusted grid regions; and estimate, based on the scheduling map, the satisfaction degree corresponding to the adjusted grid division by a satisfaction evaluation model.

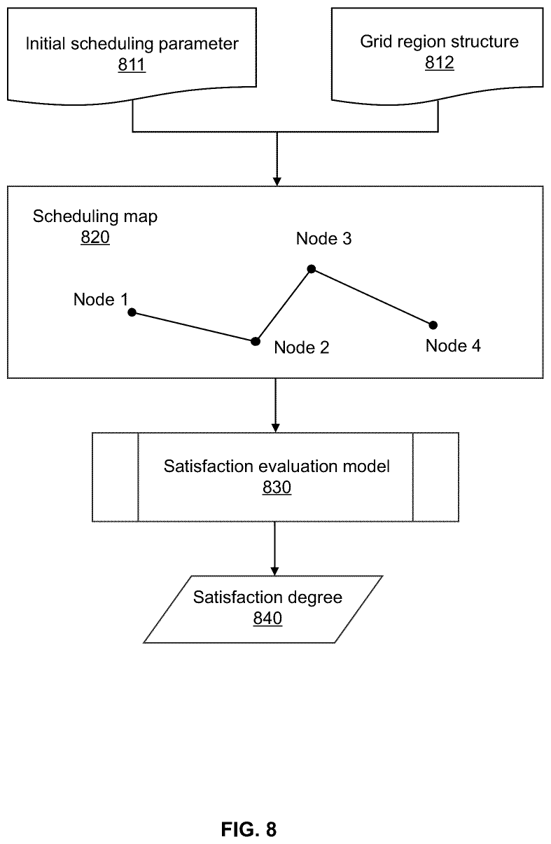

For more contents on the scheduling map construction, and the satisfaction evaluation modeling, please refer to the related descriptions in FIG. 8.

In some embodiments, the preset condition may include that the adjusted satisfaction degree corresponding to a certain adjusted grid region is not smaller than a satisfaction threshold.

The satisfaction threshold refers to a preset value used to compare with the adjusted satisfaction degree. The satisfaction threshold may reflect a level of satisfaction of the grid region on a scheduling result. In some embodiments, the gas company management platform may determine the satisfaction threshold in a variety of ways, for example, based on at least one of experience, historical data, or the like.

In some embodiments, the satisfaction threshold may be related to an area of the adjusted grid region. In some embodiments, the satisfaction threshold may be positively correlated with the area of the grid region.

In some embodiments, the gas company management platform may calculate the satisfaction threshold based on the area of the adjusted grid region by a first preset formula.

In some embodiments, the first preset formula may include, satisfaction threshold=area of the grid region×unit satisfaction threshold. For example, the area of the grid region is 100, the unit satisfaction threshold is 0.8, and the satisfaction threshold may be 100×0.8=80.

The unit satisfaction threshold may be a preset value. In some embodiments, the gas company management platform may determine the unit satisfaction threshold in various ways, for example, based on at least one of the experience, the historical data, or the like.

In some embodiments of the present disclosure, the satisfaction threshold may be made to correlate to a size of the adjusted grid region, so as to enable an adaptive adjustment of the satisfaction threshold corresponding to the grid region according to an adjustment situation of the grid region, and improve the accuracy of judging the satisfaction threshold of the grid region, thereby facilitating a subsequent improvement of the adjustment accuracy of the grid region.

In some embodiments, the second adjustment may include adjusting the grid region whose adjusted satisfaction degree is smaller than the satisfaction threshold, and the grid region whose adjusted satisfaction degree is not smaller than the satisfaction threshold, which is near the grid region whose adjusted satisfaction degree is smaller than the satisfaction threshold. For example, the gas company management platform may merge the grid region with the satisfaction degree smaller than the satisfaction threshold with the grid region whose adjusted satisfaction degree is not smaller than the satisfaction threshold, which is near the grid region whose adjusted satisfaction degree is smaller than the satisfaction threshold. If the satisfaction degree of the merged grid region is not smaller than the satisfaction threshold, the merger may be retained; if the satisfaction degree of the merged grid region is still smaller than the satisfaction threshold, the grid region with the satisfaction smaller than the satisfaction threshold may be merged with other grid regions until the satisfaction degree of the merged grid region is not smaller than the satisfaction threshold. The merged grid regions may be under the management of the same company and an area of the merged grid regions may not be greater than the aforementioned area threshold.

In some embodiments, the second adjustment may include adjusting the grid region whose adjusted demand degree is greater than a demand threshold and the adjusted satisfaction degree is smaller than the satisfaction threshold.

In some embodiments, the gas company management platform may take a grid region whose adjusted demand degree is greater than the demand threshold and whose adjusted satisfaction degree is smaller than the satisfaction threshold as a to-be-adjusted grid region, and divide the to-be-adjusted grid region equally into n grids. In some embodiments, the gas company management platform may calculate n based on a second preset formula. For example, the second preset formula may be n=cell (adjusted demand degree/demand threshold), where cell denotes a ceiling function that rounds up a result of an operation. For example, cell (3/2)=2.

In some embodiments, as shown in FIG. 6, the preset demand degree threshold may be 50 and the satisfaction threshold may be 5. The adjusted demand degree of the first grid 410 may be 80, which is greater than the demand degree threshold. The adjusted satisfaction degree may be 9, which is greater than the satisfaction threshold. The first grid region 410 may not be adjusted.

The adjusted demand degree of the first portion 431 split from the third grid region 430 may be 60, which is greater than the demand threshold. The adjusted satisfaction degree may be 9, which is greater than the satisfaction threshold. The first portion 431 does not require adjustment. The adjusted demand degree for the fourth grid region 510 may be 95, which is greater than the demand threshold, the adjusted satisfaction degree may be 4, which is smaller than the satisfaction threshold, and the fourth grid region 510 requires to be adjusted. n=cell (95/50)=2, thus the fourth grid region 510 may be divided equally into a fifth grid region 611 and a sixth grid region 612.

In some embodiments, in response to that neither the fifth grid region 611 nor the sixth grid region 612 has the adjusted satisfaction degree that is smaller than the satisfaction threshold and the adjusted demand degree that is greater than the demand degree threshold, the adjustment result may be retained; and in response to that either the fifth grid region 611 or the sixth grid region 612 has the adjusted satisfaction degree that is smaller than the satisfaction threshold and the adjusted demand degree that is greater than the demand degree threshold, the second adjustment may be performed.

In some embodiments of the present disclosure, by performing the second adjustment to the grid region, it may be possible to avoid the existence of the grid region whose gas demand degree is greater than the demand degree threshold and whose satisfaction degree is smaller than the satisfaction threshold, thereby reducing the scheduling difficulty and avoiding the insufficiency of supply capacity due to an insufficient schedulable resource, and ensuring a satisfaction of the gas user in different grid regions.

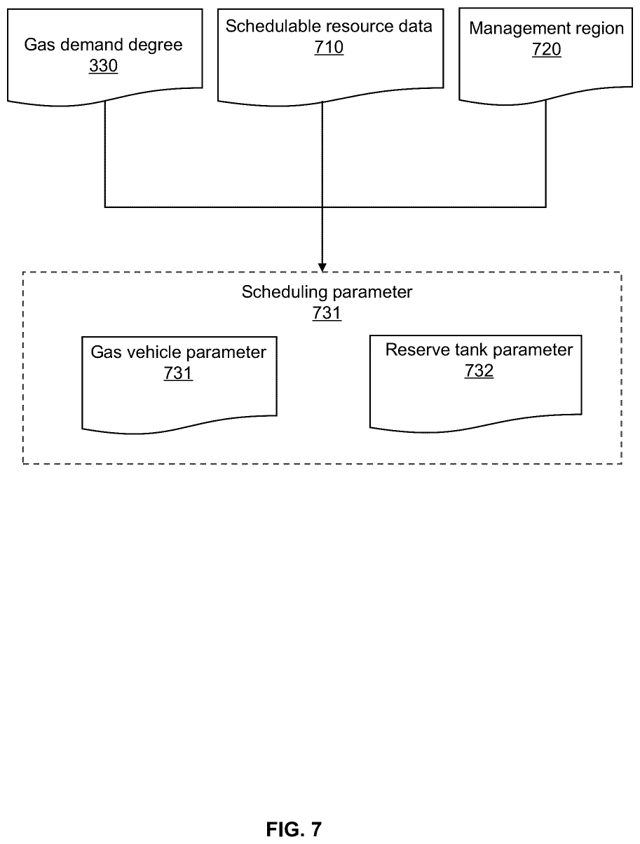

FIG. 7 is a schematic diagram illustrating a process for determining a scheduling parameter according to some embodiments of the present disclosure.

In some embodiments, the gas company management platform may determine a scheduling parameter 730 based on a gas demand degree 330 of a grid region in a future time period, schedulable resource data 710, and a management region 720 of the gas company. The scheduling parameter 730 may include at least one of a gas vehicle parameter 731 for a temporary gas vehicle, and a reserve tank parameter 732 for a gas reserve tank

For detailed descriptions of the schedulable resource data, the scheduling parameter, the grid region, and the gas demand degree, please refer to relevant descriptions of FIG. 2.

The management region refers to a region where the gas company is responsible for supplying gas. For example, the management region may be a street region, a residential region, an administrative region, or the like, or a management region determined based on the actual situation of the gas company.

In some embodiments, the gas company management platform may determine the scheduling parameter in a variety of ways. For example, the gas company management platform may determine the scheduling parameter by vector matching based on the gas demand degree in the grid region in the future time period, the schedulable resource data, and the management region.

The gas company management platform may obtain at least one clustering center by clustering the gas demand degrees, the schedulable resource data, the management regions and their corresponding scheduling parameters of each grid region at different time periods. At least one standard vector may be constructed based on the gas demand degree, the schedulable resource data, and the management region of the respective grid regions of the different time periods corresponding to the at least one clustering center.

In some embodiments, the clustering algorithm may include, but not limited to, a K-Means (K-means) clustering and/or a density-based spatial clustering of applications with noise (DBSCAN), or the like.

In some embodiments, the gas company management platform may match a to-be-matched vector with the at least one standard vector to determine the scheduling parameter. The to-be-matched vector may be constructed based on the gas demand degrees, the schedulable resource data, and the management regions for various grid regions at different future time periods. For example, the gas company management platform may match the to-be-matched vector with at least one standard vector, select a standard vector whose similarity with the to-be-matched vector satisfies a preset condition as a target standard vector, and determine, based on the scheduling parameter corresponding to the target standard vector, the scheduling parameter corresponding to the vector to be matched. The preset condition may be that the similarity is maximized, or the similarity exceeds a preset threshold. The preset threshold may be preset.

In some embodiments, the gas company management platform may also determine the scheduling parameter based on the gas demand degree in the grid region in a future time period, the schedulable resource data, and the management region by a preset algorithm.

The preset algorithm refers to an algorithm used to calculate the scheduling parameter. In some embodiments, the preset algorithm may include the following steps.
S1, encoding based on the schedulable resource data 720.

According to some embodiments, the gas company management platform may encode a number of temporary gas vehicles, a number of gas reserve tanks, and their positions in the schedulable resource data.

In some embodiments, the gas company management platform may perform the encoding operation based on a variety of encoding rules. For example, the encoding rules may include a binary encoding, a floating point encoding, a symbolic encoding, or a customized encoding manner.

Exemplarily, if specifications of each temporary gas vehicle and each gas reserve tank are exactly the same, the encoding rule may be to take a number of grid regions as a coding length (e.g., if there are four grid regions, the coding length may be 4, i.e., 4 coding elements). When each coding element takes a different coding value, the different coding value represents a distribution situation of different schedulable resources. The coding value of 1 represents that there is a temporary gas vehicle in the grid region, the coding value of 2 represents that there is a gas reserve tank in the grid region, the coding value of 3 represents that there are both a temporary gas vehicle and a gas reserve tank in the grid region, and the coding value of 0 represents that there is no temporary gas vehicle and no gas reserve tank in the grid region.

For example, if there is the temporary gas vehicle in the grid region 3 and no temporary gas vehicle or gas reserve tank in any other grid region, a corresponding candidate code may be (0, 0, 1, 0), which is also represented as 0010.

In some embodiments, if the temporary gas vehicle and the gas reserve tank have different specifications and models, respectively, they are represented by a multi-digit numeric code. For example, if there are two specifications for the temporary gas vehicles, then the temporary gas vehicles may be represented by an 11 code versus a 12 code, respectively. Understandably, the coding rule may be varied according to needs.
S2, randomly generating a plurality of initial scheduling parameters based on the aforementioned encoding.

The initial scheduling parameter refers to a preliminary determined scheduling plan for the schedulable resource, and the initial scheduling parameter may include a distribution of schedulable resource in different grid regions.

In some embodiments, the initial scheduling parameter may be represented as a vector. Elements in the vector may represent different grid regions, and values of the elements may represent a distribution situation of the schedulable resource in the different grid regions. For example, a certain initial scheduling parameter (0, 1, 0, 0) indicates scheduling the temporary gas vehicle to the second grid region, and removing the temporary gas vehicle and/or the gas reserve tank from remaining grid regions.
S3, calculating a fitness corresponding to the initial scheduling parameter.

The fitness refers to a parameter used to characterize a satisfaction degree of the initial scheduling parameter, and the fitness may be positively correlated with the satisfaction degree of the initial scheduling parameter. The higher the satisfaction degree of the initial scheduling parameter, the stronger the fitness of the initial scheduling parameter, and the more likely the initial scheduling parameter is to be determined as the final scheduling parameter.

In some embodiments, the gas company management platform may determine, based on a satisfaction evaluation model 830, the satisfaction degree of a user in the grid region when scheduling the schedulable resource in the grid region based on the initial scheduling parameter.

In some embodiments, the satisfaction degree output by the satisfaction evaluation model 830 may be determined as the fitness corresponding to the initial scheduling parameter. For more contents of the satisfaction evaluation model 830 may be referred to in FIG. 8.
S4, screening the initial scheduling parameter to determine at least one first candidate scheduling parameter.

In some embodiments, for each of the plurality of initial scheduling parameters, the gas company management platform may determine a selection parameter for the initial scheduling parameter based on the fitness corresponding to the initial scheduling parameter.

The selection parameter may be used to indicate a probability that the initial scheduling parameter is determined to be the first candidate scheduling parameter, and the selection parameter of the initial scheduling parameter may be positively correlated with the fitness value. For example, the selection parameter may be determined based on a roulette counter.

Exemplarily, the probability that an initial scheduling parameter is selected may be a proportion of the fitness of the initial scheduling parameter to a sum of the fitness of all the initial scheduling parameters. For example, the fitness of the five initial scheduling parameters may be 1,2,3,4,5, the probability of their selection may be 1/15, 2/15, 3/15, 4/15, 5/15, respectively.

In some embodiments, the gas company management platform may determine a plurality of first candidate scheduling parameters from the plurality of initial scheduling parameters based on the selection parameter corresponding to each of the plurality of initial scheduling parameters. For example, an initial scheduling parameter with a selection parameter that is greater than a preset selection parameter threshold may be determined as the first candidate scheduling parameter.
S5, processing the plurality of first candidate scheduling parameters based on a preset rule to obtain second candidate scheduling parameters and third candidate scheduling parameters.

In some embodiments, the preset rule may include a first transformation, a second transformation. The first transformation refers to exchanging a parameter of the same element in a plurality of different first candidate scheduling parameters, and the second transformation refers to adjusting a value of a certain element in the first candidate scheduling parameters.

In some embodiments, the gas company management platform may perform the first exchange on the plurality of first candidate scheduling parameters to generate a plurality of second candidate scheduling parameters. For example, the first candidate scheduling parameter 1 may be (1, 0, 2, 0), the first candidate scheduling parameter 2 may be (0, 0, 2, 1), and the parameter corresponding to the first element in a first candidate scheduling parameter 1 may be exchanged with the parameter corresponding to the first element in a first candidate scheduling parameter 2, to generate the second candidate scheduling parameters of (0, 0, 2, 0), (1, 0, 2, 1).

In some embodiments, the gas company management platform may perform the second transformation on the plurality of second candidate scheduling parameters to generate a plurality of third candidate scheduling parameters. For example, the first candidate scheduling parameter 1 may be (1, 0, 2, 0), then the parameter corresponding to the second element in scheme 1 may be adjusted, i.e., 0 may be modified to 1. The new second candidate scheduling parameter generated after the modification may be (1, 1, 2, 0).

In some embodiments, the processor may transform a portion of the plurality of second candidate scheduling parameters to generate the plurality of third candidate scheduling parameters. For example, 5% of a total number of schemes in the second candidate scheduling parameters may be randomly selected for the transformation.

In some embodiments, the gas company management platform may eliminate non-compliant second candidate scheduling parameters and/or third candidate scheduling parameters based on an actual number of schedulable resources.

In some embodiments, the number of schedulable resources in any of the second candidate scheduling parameter and/or the third candidate scheduling parameter may not exceed the actual number thereof, otherwise, the second candidate scheduling parameter and/or the third candidate scheduling parameter may be considered to be non-compliant.

For example, if the actual number of schedulable resource devices is 2 temporary gas vehicles and 2 reserve gas tanks, and if the candidate scheduling parameter obtained after the above transformation is (1, 1, 3, 0), and the scheme requires 3 temporary gas vehicles, which is more than the actual number of temporary gas vehicles, the candidate scheduling parameter may be determined to be not in compliance with the requirement, and the candidate scheduling parameter may be eliminated.
S6, eliminating undesirable the initial scheduling parameters.
In some embodiments, the processor may rank the initial scheduling parameters based on the fitness in a descending order, eliminate the initial scheduling parameters whose fitness are lower than a preset rank, and replace the eliminated initial scheduling parameters with the aforementioned second candidate scheduling parameters and the third candidate scheduling parameters to form a new set of scheduling parameters, and perform the next round of transformation based on the new set of scheduling parameters.

S7, repeating S3-S6, and continuing the iterative transformation until an end condition is satisfied, and the scheduling parameter with the greatest fitness value may be determined as the target scheduling parameter.

In some embodiments, the end condition may include at least one of a number of iterations reaching a preset number threshold, the fitness reaching a preset fitness value, or a difference in fitness values before and after two consecutive iterations being less than a preset difference threshold. The preset condition may be preset by the user.

The scheduling parameters may be determined using a preset algorithm from a plurality of sets of gas demand degrees, schedulable resource data, and management region data in the grid region over a future time period. In this way, more preferable scheduling parameters may be selected based on the fitness, so that the schedulable resource may be better distributed, thereby supplying gas in a reasonable and efficient manner, and ensuring continuity and safety of the gas supply in each region.

By determining the scheduling parameters based on the gas demand degree, the schedulable resource data, and the management region in the grid region a distribution on demand may be achieved, so as to avoid an excessive wastage of the gas resources, and ensure that the gas demand of the residents is satisfied.

FIG. 8 is a schematic diagram illustrating a process for determining a satisfaction degree of an initial adjustment parameter according to some embodiments of the present disclosure.

In some embodiments, a preset algorithm may include determining the satisfaction degree of the initial scheduling parameter, and a gas company management platform may construct a scheduling map 820 based on an initial scheduling parameter 811 and a grid region structure 812. The gas company management platform may further determine, based on the scheduling map 820, a satisfaction degree 840 of gas users in each grid region with respect to an effect of gas supply after scheduling a schedulable resource based on the initial scheduling parameter through a satisfaction evaluation model 830. For more contents on the initial scheduling parameter, please refer to descriptions in FIG. 7.

The grid region structure refers to a structure distribution of the region after gridding. For detailed descriptions of the gridding, please refer to relevant descriptions of FIG. 2.

The scheduling map refers to a map reflecting the schedulable resource and a position distribution of the schedulable resource in the grid region. In some embodiments, the scheduling map may include nodes and edges.

In some embodiments, after scheduling the schedulable resource devices based on the initial scheduling parameter, the scheduling map may be constructed based on the distributions of the schedulable resources in different grid regions, as well as a structure of the grid regions. At this point, by inputting the scheduling map into the satisfaction evaluation model, the satisfaction degree of the gas users in the various grid regions with respect to the effect of gas supply after the scheduling may be determined after scheduling the schedulable resource devices based on the initial scheduling parameter.

In some embodiments, the nodes may be used to indicate the grid regions. A node feature may include a respective peak gas demand corresponding to each of the grid regions, a time corresponding to the peak, a demand time period, a schedulable resource device situation, and schedulable resource data.

The demand time period refers to a time range in which the gas user needs to use gas.

In some embodiments, the schedulable resource device situation of a node may be used to indicate the distribution of the schedulable resource in the grid region corresponding to the node. For example, the schedulable resource situation of the node may be indicated by a numerical code, 0 indicates that the node is not configured with the schedulable resource, 1 indicates that the node is configured with a temporary gas vehicle, 2 indicates that the node is configured with a reserve gas tank, 3 indicates that the node is configured with both the temporary gas vehicle and the reserve gas tank.

In some embodiments, the schedulable resource data of a node may be determined based on a configuration situation of the schedulable resource in the grid region corresponding to the node. For example, if the node is not configured with the schedulable resource, the schedulable resource data corresponding to the node may be indicated as 0. If the node is configured with the schedulable resource, the schedulable resource data corresponding to the node may be determined based on an actual configuration situation of the schedulable resource. For detailed descriptions of the schedulable resource data, please refer to relevant descriptions in FIG. 2 of the present disclosure.

In some embodiments, the edges may be used to indicate relationships between the nodes.

In some embodiments, the edges may be determined by the following rules.

In some embodiments, the edges may be determined based on an adjacency of the grid regions, and if two grid regions are adjacent to each other, an edge may exist between their respective corresponding nodes, and the adjacency refers to that there is an overlapping portion of boundary lines of the two grid regions.

In some embodiments, the edges may be determined based on a scheduling range of the schedulable resource in the grid region, e.g., if there is a schedulable resource in the grid region A, and the grid region B is in the scheduling range of the schedulable resource, then grid region A and grid region B may have an edge between their corresponding nodes.

The schedule range of the schedulable resource refers to the maximum range that the schedulable resource is able to supply. The schedule range may include at least one of a range of movement of the temporary gas vehicle, and a range of supply of the reserve gas tank.

In some embodiments, there may be a situation where at least one of two adjacent nodes is set up with the schedulable resource, in this case, it may be determined that the two nodes have connected edges between them without a need to repeat the drawing.

In some embodiments, in response to that at least one of the two nodes connected by the edge has the schedulable resource, the edge feature corresponding to the edge may include a scheduling time for scheduling the schedulable resource between the two nodes. The scheduling time refers to a time it takes for the temporary gas vehicle or the reserve gas tank to be scheduled from a position to a target schedule position. The target schedule position refers to a target position to which the schedulable resource is to be moved.

In some embodiments, the scheduling time may be obtained in various ways. For example, the scheduling time may be obtained based on a calculation. Exemplarily, the schedule time of the temporary gas vehicle may be calculated by the following formula (1):

t₁=S₁/v₁ (1)

where, t₁ denotes the scheduling time, v₁ denotes a movement speed of the temporary gas vehicle, and S₁ denotes a distance between a current position of the temporary gas vehicle and the target scheduling position. It may be understood that if the scheduling time of the gas reserve tank is calculated, v₁ may denote a transportation rate of the gas reserve tank.

In some embodiments, in response to that no schedulable resource is set up in either of the two nodes connected by the edge, the edge feature corresponding to the edge may be marked as 0, indicating that there is no movement of the schedulable resource between the above two nodes.

The satisfaction degree may be an indicator used to characterize a level of satisfaction of the gas user on a gas use. In some embodiments, the satisfaction degree may be indicated in a variety of ways, for example, a number, a percentage, a rating, or the like. For example, the satisfaction degree may be 70%, 80%, etc.

A satisfaction evaluation model is a model for estimating the satisfaction degree. In some embodiments, the satisfaction evaluation model may be a machine learning model. For example, the machine learning model may be a graph neural networks (GNN) model, etc.

In some embodiments, an input of the satisfaction evaluation model may be the scheduling map, and an output of the satisfaction evaluation model may be the satisfaction degrees corresponding to the individual nodes.

In some embodiments, the satisfaction evaluation model may be obtained by training a great number of first training samples with first labels. The first training samples may include the scheduling maps in sample historical data, and the scheduling maps in the historical data may be constructed based on historical scheduling parameters and a historical grid region structure. The first training samples may be obtained from the historical data. The first labels may be historical actual satisfaction degrees of the user on the historical scheduling parameters, and the foregoing historical actual satisfaction degree may be determined based on actual user feedbacks.

In some embodiments, the processor may average the satisfaction degree corresponding to each node to determine a final satisfaction degree, and use the final satisfaction degree as the satisfaction degree of the user on a gas supply situation after scheduling the schedulable resource based on the initial scheduling parameters. The final satisfaction degree refers to an indicator used to comprehensively evaluate the satisfaction degrees of all nodes. Exemplarily, the final satisfaction degree may also be a sum of the corresponding satisfaction degrees of the individual nodes.

In the embodiment of the present disclosure, by constructing the scheduling map, and determining, based on the scheduling map, the satisfaction degree of the gas user on the gas supply situation after scheduling a schedulable resource based on different scheduling parameters by means of a satisfaction evaluation model, the scheduling situation in the various grid region may be obtained. Based on the model, the satisfaction degrees of the users may be reasonably evaluated, which helps in adjusting the scheduling parameters, and realizing a rationalization and intelligence of the gas scheduling.

The basic concepts have been described above, and it is apparent to those skilled in the art that the foregoing detailed disclosure is intended as an example only and does not constitute a limitation of the present disclosure. While not expressly stated herein, those skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment,” “one embodiment,” and/or “some embodiment” means a feature, structure, or characteristic associated with at least one embodiment of the present disclosure. Accordingly, it should be emphasized and noted that “one embodiment” or “one embodiment” referred to two or more times in different positions in the present disclosure or “a number of embodiments” means a feature or characteristic related to at least one embodiment of the present disclosure. The “an embodiment” or “an alternative embodiment” in different places in the present disclosure do not necessarily refer to the same embodiment. In addition, certain features, structures, or characteristics of one or more embodiments of the present disclosure may be suitably combined.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for guaranteeing a smart gas demand based on a regulatory Internet of Things (IoT), wherein the method is executed by a gas company management platform of a system for guaranteeing the smart gas demand based on the regulatory IoT, the method comprising:
obtaining a plurality of regions by gridding a regulatory scope;
predicting a gas demand degree of each of the plurality of grid regions in a future time period based on weather data, people flow data, historical gas data, and a gas consumption plan of the each of the plurality of grid regions, and an authenticity degree corresponding to the gas consumption plan;
determining a scheduling parameter based on the gas demand degree and schedulable resource data in the future time period; and
generating a scheduling instruction based on the scheduling parameter, and sending the scheduling instruction to a terminal device corresponding to a schedulable resource.

2. The method of claim 1, wherein the system for guaranteeing the smart gas demand based on the regulatory IoT includes a civilian user platform, a government regulatory service platform, a government regulatory management platform, a government regulatory sensor network platform, a government regulatory object platform, a gas company sensor network platform, and a gas device object platform;
the government regulatory service platform includes a government safety regulatory service platform; the government regulatory management platform includes a government safety regulatory management platform; and the government regulatory object platform includes the gas company management platform.

3. The method of claim 2, wherein the gas company management platform includes a processor and a communication module, and the processor is configured to:
obtain the weather data and the people flow data from the government regulatory service platform by the communication module;
obtain the schedulable resource data from the gas device object platform by the communication module, the gas device object platform including the schedulable resource device;
obtain the gas consumption plan from the civilian user platform by the communication module, and obtaining the authenticity degree of the gas consumption plan; and
send the scheduling instruction to the terminal device corresponding to the schedulable resource device by the communication module to control scheduling of the schedulable resource device.

4. The method of claim 1, wherein the method further comprises:
determining a plurality of adjusted grid regions by performing a first adjustment on each of the plurality of grid regions based on the gas demand degree of each of the plurality of grid regions and a plurality of management regions of a plurality of gas companies; wherein
the gas demand degree is determined by a demand prediction model based on the weather data, the people flow data, the historical gas data, the gas consumption plan, and the authenticity degree, the demand prediction model being a machine learning model.

5. The method of claim 4, wherein an input of the demand prediction model further includes a historical demand degree and a historical satisfaction degree of each of the plurality of grid regions in a historical time period.

6. The method of claim 4, wherein the method further comprises:
performing a second adjustment on the adjusted grid region whose adjusted satisfaction degree does not meet a preset condition, based on an adjusted demand degree and the adjusted satisfaction degree of each of the plurality of the adjusted grid regions, the preset condition including that the adjusted satisfaction degree of the adjusted grid region is less than a satisfaction threshold; wherein
the adjusted demand degree is determined by the demand prediction model based on the weather data, the people flow data, the historical gas data, the gas consumption plan, and the authenticity degree of the adjusted grid regions.

7. The method of claim 6, wherein the satisfaction threshold is related to an area of the adjusted grid region.

8. The method of claim 1, wherein the determining a scheduling parameter based on the gas demand degree and schedulable resource data in the future time period includes:
determining the scheduling parameter based on the gas demand degree of each of the plurality of grid regions in the future time period, the schedulable resource data, and a management region of a gas company.

9. The method of claim 8, wherein the determining the scheduling parameter based on the gas demand degree of each of the plurality of grid regions in the future time period, the schedulable resource data, and the management region of the gas company, further includes:
determining the scheduling parameter by a preset algorithm based on the gas demand degree of each of the plurality of grid regions in the future time period, the schedulable resource data, and the management region.

10. The method of claim 9, wherein the schedulable resource includes a temporary gas vehicle and a gas reserve tank; and
the scheduling parameter includes at least one of a gas vehicle parameter of the temporary gas vehicle, and a reserve tank parameter of the gas reserve tank.

11. A system for guaranteeing a smart gas demand based on a regulatory Internet of Things (IoT), wherein the system includes a civilian user platform, a government regulatory service platform, a government regulatory management platform, a government regulatory sensor network platform, a government regulatory object platform, a gas company sensor network platform, and a gas device object platform;
the government regulatory service platform includes a government safety regulatory service platform;
the government regulatory management platform includes a government safety regulatory management platform;
the government regulatory object platform includes a gas company management platform;
wherein the gas company management platform is configured to:
obtain a plurality of grid regions by gridding a regulatory scope;
predict a gas demand degree of each of the plurality of grid regions in a future time period, based on weather data, people flow data, historical gas data, and a gas consumption plan of each of the plurality of grid regions, and an authenticity degree of the gas consumption plan;
determine a scheduling parameter based on the gas demand degree and schedulable resource data in the future time period;
generate a scheduling instruction based on the scheduling parameter, and send the scheduling instruction to a terminal device corresponding to a schedulable resource device.

12. The system of claim 11, wherein the gas company management platform includes a processor, and a communication module, and the processor is configured to:
obtain the weather data and the people flow data from the government regulatory service platform by the communication module;
obtain the schedulable resource data from the gas device object platform by the communication module, the gas device object platform including the schedulable resource device;
obtain the gas consumption plan from the civilian user platform by the communication module, and obtain the authenticity degree of the gas consumption plan;
send the scheduling instruction to the terminal device corresponding to the schedulable resource device by the communication module to control the scheduling of the schedulable resource device.

13. The system of claim 11, wherein the gas company management platform is further configured to:
determine a plurality of adjusted grid regions by performing a first adjustment on each of the plurality of grid regions based on the gas demand degree of each of the plurality of grid regions and a plurality of management regions of a plurality of gas companies; wherein
the gas demand degree is determined by a demand prediction model based on the weather data, the people flow data, the historical gas data, the gas consumption plan and the authenticity degree, the demand prediction model being a machine learning model.

14. The system of claim 13, wherein an input of the demand prediction model further includes a historical demand degree and a historical satisfaction degree of each of the plurality of grid regions in a historical time period.

15. The system of claim 13, wherein the gas company management platform is further configured to:
perform a second adjustment on the adjusted grid region whose adjusted satisfaction degree does not meet a preset condition, based on an adjusted demand degree and the adjusted satisfaction degree of each of the plurality of the adjusted grid regions, the preset condition including that the adjusted satisfaction degree of the adjusted grid region is less than a satisfaction threshold; wherein
the adjusted demand degree is determined by the demand prediction model based on the weather data, the people flow data, the historical gas data, the gas consumption plan, and the authenticity degree of the adjusted grid region.

16. The system of claim 15, wherein the satisfaction threshold is related to an area of the adjusted grid region.

17. The system of claim 11, where in the gas company management platform is further configured to:
determine the scheduling parameter based on the gas demand degree of each of the plurality of grid regions in the future time period, the schedulable resource data, and a management region of a gas company.

18. The system of claim 17, wherein the gas company management platform is further configured to:
determine the scheduling parameter by a preset algorithm based on the gas demand degree of each of the plurality of grid regions in the future time period, the schedulable resource data, and the management region.

19. The system of claim 18, wherein the schedulable resource includes a temporary gas vehicle and a gas reserve tank;
the scheduling parameter includes at least one of a gas vehicle parameter of the temporary gas vehicle, and a reserve tank parameter of the gas reserve tank.

20. A non-transitory computer-readable storage medium, the storage medium storing computer instructions, and when the computer reads the computer instructions in the storage medium, the computer executes the method for guaranteeing a smart gas demand based on a regulatory Internet of Things (IoT) of claim 1.
